(19) United States
(12) Patent Application Publication
(10) Pub. No.: US 2015/0197903 A1
(43) Pub. Date: Jul. 16, 2015

(54) PET CLEANING BAG

(71) Applicants: Nicole Curran, Green Bay, WI (US); Regina Angeli, Kingsford, MI (US)

(72) Inventors: Nicole Curran, Green Bay, WI (US); Regina Angeli, Kingsford, MI (US)

(21) Appl. No.: 14/153,876

(22) Filed: Jan. 13, 2014

(51) Int. Cl. E01H 1/12; A01K 13/00

(52) U.S. Cl. CPC E01H 1/1206; A01K 13/001

(57) ABSTRACT

A bag for cleaning a dog's behind and picking up the dog's waste is provided. The bag may include an outer surface and an inner surface. A towel portion may be attached to the bag and may cover a portion of the outer surface of the bag. After the dog has defecated, a user may place their hand within the inner surface of the bag, and wipe the dog's behind and then pick up the dog's waste using the bag.

### CROSS-REFERENCE TO RELATED APPLICATION

This application claims the benefit of priority of U.S. provisional application No. 61/751,738, filed Jan. 11, 2013, the contents of which are herein incorporated by reference.

### BACKGROUND OF THE INVENTION

The present invention relates to a bag for picking up defecation and, more particularly, to a bag that cleans a pet and picks up defecation.

Dogs often defecate while the owner is taking the dog for a walk. Most municipalities require the waste to be picked up and removed. Further, the dog often needs to be cleaned after the dog defecates. Currently, bags that are used to clean the dog may include gel. However, during cold weather, the gel may not be practical. Further, it is cumbersome to use one product to clean the dog and another product to pick up the defecation.

As can be seen, there is a need for an improved device that allows a user to clean the dog and pick up the dog's defecation.

### SUMMARY OF THE INVENTION

In one aspect of the present invention, a pet cleanup aid comprises: a bag comprising an outer surface and an inner surface; and a towel portion attached to the bag and covering a portion of the outer surface of the bag.

In another aspect of the present invention, a method of cleaning after a pet has defecated comprises: providing a bag comprising a towel portion attached to a portion of the outer surface of the bag; cleaning a dog's behind with the towel portion after the dog has defecated; and picking up the defecation with the bag.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a front view of the present invention;

FIG. 3 is a section detail view of the present invention along line 3-3 in FIG. 2;

FIG. 4 is a front view of the invention demonstrated with the insertion of an exemplary hand into the bag of FIG. 1;

FIG. 5 is a perspective view of the present invention shown in use;

FIG. 6 is an exploded view of the present invention demonstrating usage;

FIG. 7 is a perspective view of the present invention demonstrating usage;

FIG. 8 is a section detail view of the present invention along line 8-8 in FIG. 7; and

FIG. 9 is an exploded view of the present invention demonstrating removal of the hand from the bag of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bag for cleaning a dog's behind and picking up the dog's waste. The bag may include an outer surface and an inner surface. A towel portion may be attached to the bag and may cover a portion of the outer surface of the bag. After the dog has defecated, a user may place their hand within the inner surface of the bag, and wipe the dog's behind and then pick up the dog's waste using the bag.

The present invention may include a biodegradable dog waste bag that has a biodegradable towel affixed to the outside of the bag. After the dog has defecated, the dog walker may insert their hand into the bag and wipe the dog's behind with the exposed towel. Then the user may pick up the waste with the bag on the user's hand and turn the bag inside out to dispose of the waste. The present invention may be used by one free hand to clean the animal and then pick up the waste to dispose of it.

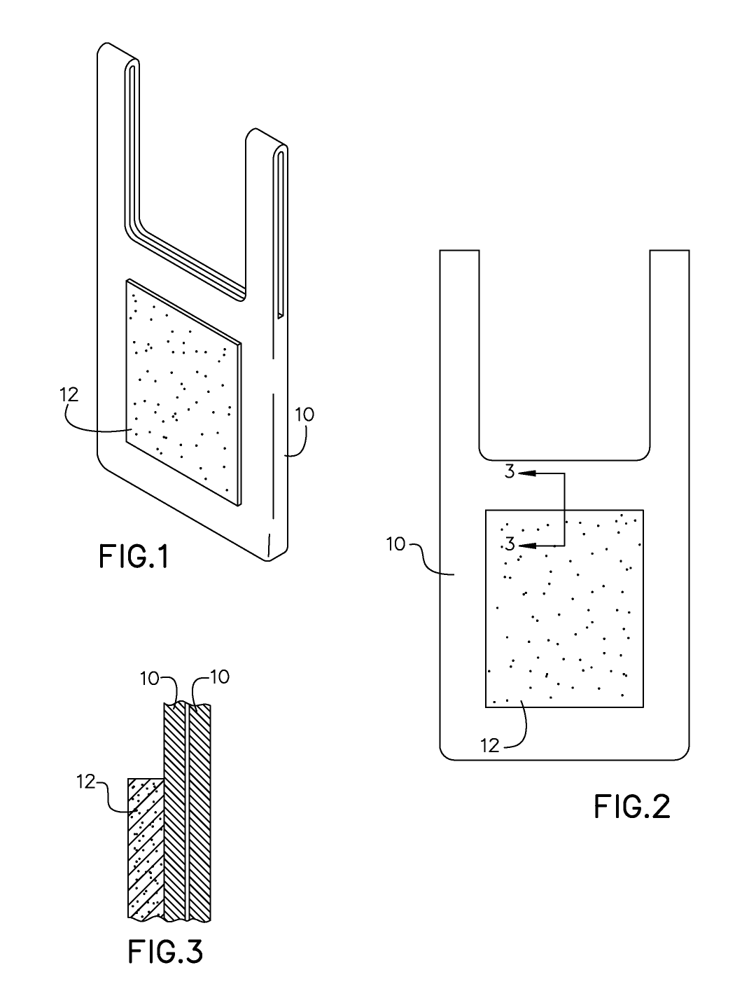

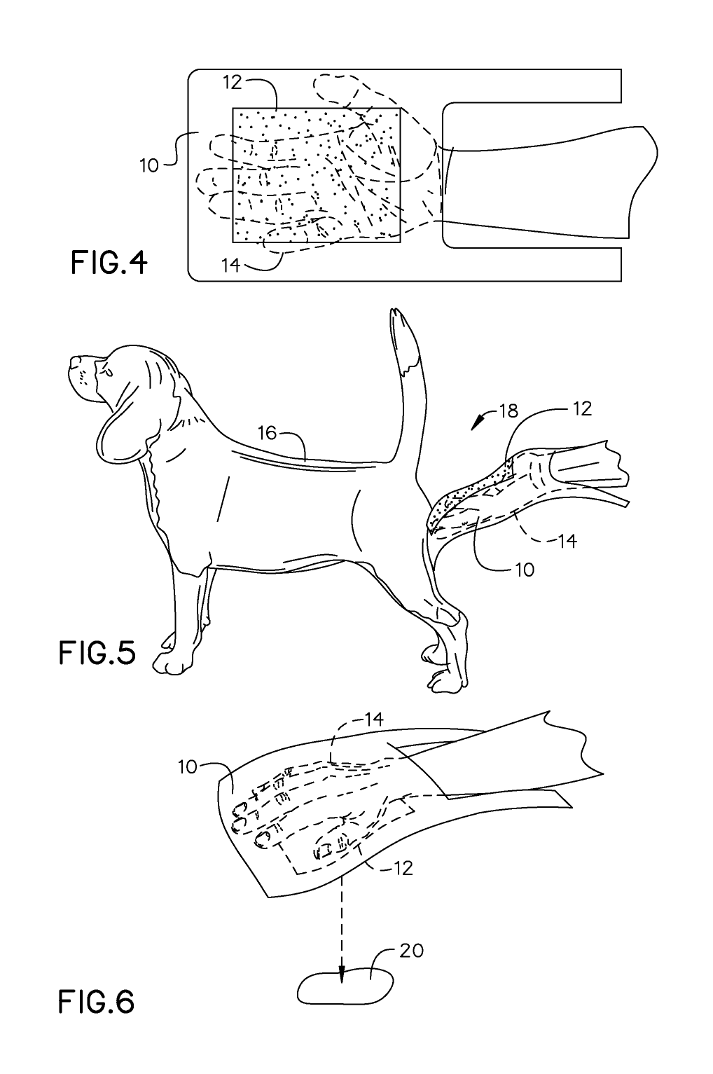

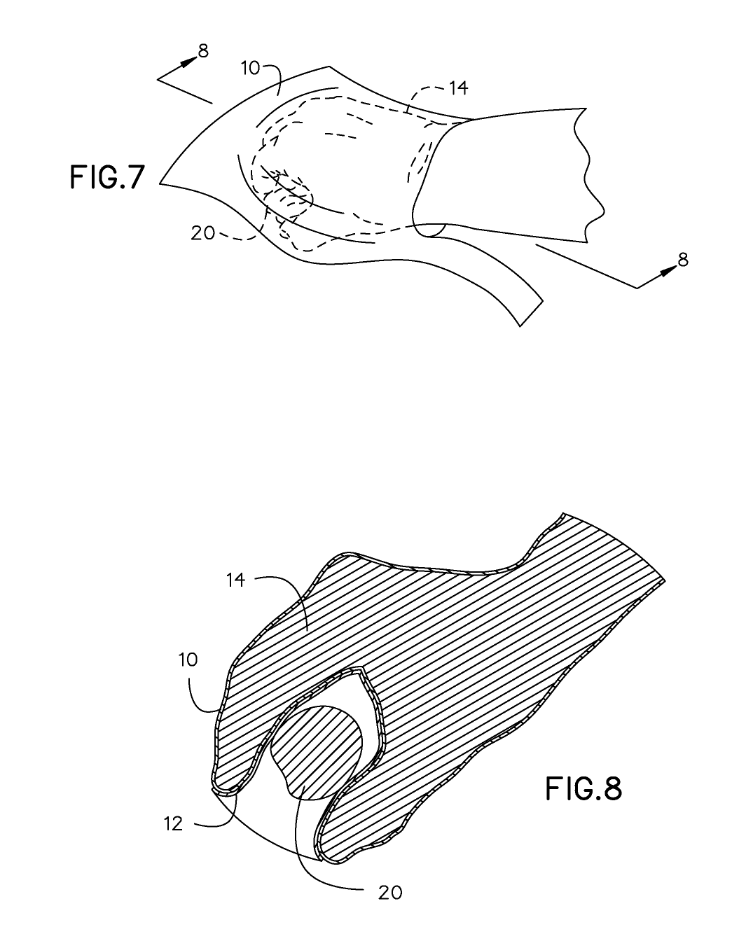

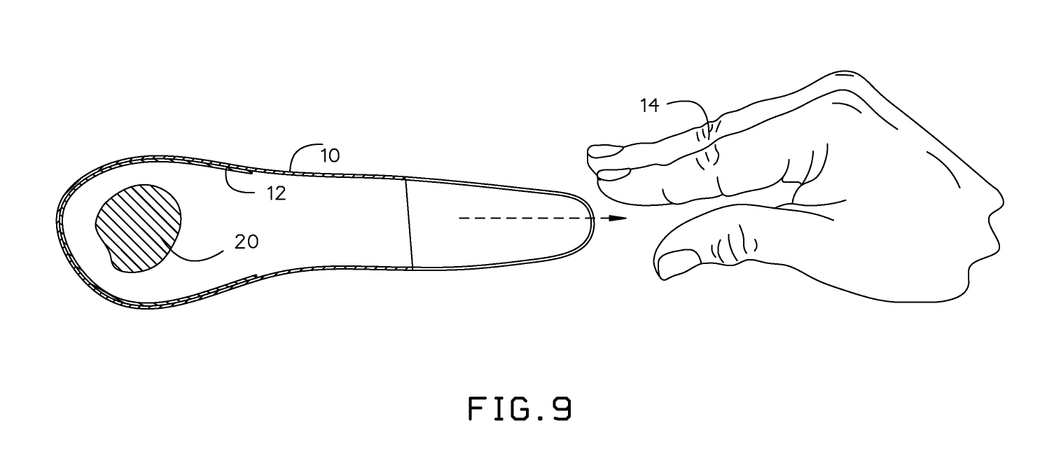

Referring to FIGS. 1 through 9, the present invention includes a bag 10. The bag 10 may include an outer surface and an inner surface. The present invention may further include a towel portion 12. The towel portion 12 may be attached to the bag 10 and may cover a portion of the outer surface of the bag 10. After the dog has defecated, a user 14 may place their hand within the inner surface of the bag 10, and wipe the dog's 16 behind and then pick up the dog's waste 20.

In certain embodiments, the towel portion 12 of the bag 10 may be made of at least one of a biodegradable material, a compostable material, and a flushable material. In certain embodiments, the towel portion 12 may be made of a cloth material. The towel portion 12 may be embedded in the bag 10 or may be attached to the outer surface of the bag 10 by an adhesive, such as glue. In certain embodiments, the towel portion 12 may moist or contain a lotion or liquid cleaning solution. In certain embodiments, the towel portion 12 may be soft, absorbent, and dry, which allows for frequent usage without irritation of the pet's behind. Further, when the towel portion 12 is dry, the towel 12 may still be used during extremely cold weather.

The bag 10 of the present invention may be made of a biodegradable material, a compostable material, and a flushable material. Alternatively, the bag 10 may be made of a polymer, such as plastic. The bag 10 may be similar to other bags used to pickup and dispose of dog's waste. In certain embodiments, the bag may include extensions protruding from near the entrance to the bag 10. Therefore, a user 14 may easily tie the bag 10 off when disposing of the waste.

A method of making the present invention may include the following. Cut swatches out of a towel that fit on the waste bag. Since the bag is delicate in nature, the towel may be glued to the bag carefully with an adhesive. Alternatively, the towels may be made embedded in the surface of the bag.

A method of cleaning after a pet has defecated may include the following. A bag having a towel portion attached to a portion of the outer surface of the bag may be provided. Once the dog has defecated, a user may stick their hand within the bag and clean the dog's behind with the towel portion of the bag. Once the dog's behind is cleaned, the user may grab the waste with the bag and fold the bag inside out. The user may then tie together a plurality of extensions that protrude from the entrance of the bag to close the bag and then throw the bag away.

It should be understood, of course, that the foregoing relates to exemplary embodiments of the invention and that modifications may be made without departing from the spirit and scope of the invention as set forth in the following claims.

What is claimed is:

1. A pet cleanup aid comprising:
a bag comprising an outer surface and an inner surface; and
a towel portion attached to the bag and covering a portion of the outer surface of the bag.

2. The pet cleanup aid of claim 1, wherein the towel portion is embedded in the bag.

3. The pet cleanup aid of claim 1, wherein the towel portion is attached to the outer surface of the bag.

4. The pet cleanup aid of claim 1, wherein the bag is substantially made of a polymer.

5. The pet cleanup aid of claim 1, wherein the towel is made of a cloth material.

6. The pet cleanup aid of claim 1, further comprising a pair of handle protrusions extending passed the entrance to the bag.

7. The pet cleanup aid of claim 1, wherein the bag and the towel are made of at least one of biodegradable material, a compostable material, and a flushable material.

8. A method of cleaning after a pet has defecated comprising:
providing a bag comprising a towel portion attached to a portion of the outer surface of the bag;
cleaning a dog's behind with the towel portion after the dog has defecated; and
picking up the defecation with the bag.

9. The method of claim 5, further comprising turning the bag inside out after the defecation has been picked up with the bag.

10. The method of claim 6, further comprising the step of tying a plurality of extensions together that are protruding from the entrance of the bag.
